(19) United States
(12) Patent Application Publication
(10) Pub. No.: US 2022/0170375 A1
(43) Pub. Date: Jun. 2, 2022

(54) HONEYCOMB-LIKE HELICALLY CAVITY COOLING STRUCTURE OF TURBINE BLADE

(71) Applicant: DALIAN UNIVERSITY OF TECHNOLOGY, Dalian, Liaoning (CN)

(72) Inventors: Dong LV, Dalian, Liaoning (CN); Nan WANG, Dalian, Liaoning (CN); Xiaofang WANG, Dalian, Liaoning (CN); Xingao KONG, Dalian, Liaoning (CN); Yinan SUN, Dalian, Liaoning (CN)

(21) Appl. No.: 17/433,985

(22) PCT Filed: Dec. 15, 2020
(86) PCT No.: PCT/CN2020/136325

§ 371 Date: Aug. 25, 2021

(30) Foreign Application Priority Data
Jan. 6, 2020 (CN) 202010008195.X

(51) Int. Cl. F01D 5/18

(52) U.S. Cl. CPC F01D 5/186; F05D 2220/32; F05D 2260/202; F01D 5/18

(57) ABSTRACT

The present invention belongs to the technical field of turbine cooling of aero-engine and gas turbine, and relates to the honeycomb-like helically cavity cooling structure of turbine blade. The honeycomb-like helically cavity cooling structure of turbine blade includes hollow turbine blade, honeycomb-like helically cavity and pin fins. Some cooling channels are arranged inside the hollow the hollow turbine blade, the cooling gas flows through the tunnels and cools the blade. Multi-arrays of honeycomb-like helically cavity are arranged in the blade wall, for cooling gas to enter and convective cooling. A cylindrical pin fin is arranged in the center of the honeycomb-like helically cavity. In each unit, the inlet hole and film hole are located on both sides of the blade wall, and the center lines of them are parallel in the same vertical plane.

### FIELD OF THE INVENTION

The present invention belongs to the technical field of turbine cooling of aero-engine and gas turbine, and more particularly, relates to a honeycomb-like helically cavity cooling structure of turbine blade.

### BACKGROUND OF THE INVENTION

In the field of aero-engine and gas turbine, measure taken to improve the efficiency of the engine is usually to increase the gas temperature in front of the turbine. However, the bearable limitation of the current materials used is well below the gas temperature. Lead to the cooling problem of turbine blade was high-profile. Current cooling measures generally include internal strengthening convection and external formation gas film isolation. The principle of design is to use the least air-condition amount to take away as much heat as possible, protect the parts in a low temperature range and make the smaller temperature gradient. Specifically, the blade is hollow, so that the cooling gas flows in it to strengthen heat and form the gas film to isolate direct heating of gas when the cooling gas are discharged from the blades. On this basis, the pursuit of ‘greater internal heat exchange area’, ‘higher heat exchange efficiency’, ‘better coverage effect’, ‘smaller flow resistance’, ‘higher structure intensity’, ‘better buildability and maintainability’, etc.

At present, Lamilloy is a type of scheme to solve the cooling problem of turbine blade, referring to FIG. 1, its main feature is that the outer wall of blade is composed of multi-layer structure. The main structure of the Lamilloy includes an intake plate located inside the blade, an exhaust plate located outside the blade. At work, cooling gas enters the Lamilloy through the intake from the inner cavity of the blade, after heat exchange with pins and other structures, then discharged through film hole and formed gas film on the outer surface of the blade. The main feature of this scheme is that organically combine heat conduction, convection cooling, shock cooling, and film cooling. It has the advantages of large heat exchange area and full utilization of cooling gas. But at the same time, it also has the disadvantages of complex structure, difficult manufacturing, large flow resistance and weak strength.

### SUMMARY OF THE INVENTION

The honeycomb-like helically cavity cooling structure has been invented in view of the shortcomings of the existing turbine blade laminate cooling structure.

The technical solution of the invention is as follows:
Referring to FIG. 2, the honeycomb-like helically cavity cooling structure of turbine blade includes hollow turbine blade, honeycomb-like helically cavity and pin fins.

Some cooling gas channels are arranged inside the hollow turbine blade, the cooling channels (2) provide low-temperature cooling gas to flow inside the blade and cools the blade.

Multi-arrays of honeycomb-like helically cavity are arranged in the blade wall of the hollow turbine blade, for cooling gas to enter and convective cooling. A cylindrical pin fin is arranged in the center of the honeycomb-like helically cavity, makes the heat transfer area larger and guides cooling gas. The cool gas rotates around the pin fin in the honeycomb-like helically cavity and then flows out of the blade, and forms a film covering on surface of the blade.

Each honeycomb-like helically cavity is a unit with a regular hexagon shape. Multi-units are arranged as a hive, in this way, more cooling structures could be arranged in the unit area to make full use of space and formed a rich heat exchange area. Relative to typical laminated structures, the design of relatively independent unit ensures uniform flow and avoid the interaction of various air conditioners.

In each unit, inlet hole and film hole are located on both sides of the blade wall, and the center line of the inlet hole and film hole are parallel in the same vertical plane. The angle between the center line of inlet hole and the horizontal plane is incident angle ∠A1, the angle between the center line of film hole and the horizontal plane is exit angle ∠A2. The incident angle ∠A1 and exit angle ∠A2 are both acute.

In detail, the cross section is rectangle of inlet hole and film hole, inlet hole and film hole are smoothly connected with cavity by the circular arc slide. In detail, the incident angle ∠A1 and exit angle ∠A2 are both 20-45°. The typical angle of the incident angle ∠A1 and exit angle ∠A2 are 30°.

The invention mainly solved technical problems:
The cooling unit is arranged as a honeycomb array in the blade wall, which made the cooling gas more directly act on the hot wall and improve the effectiveness of the cooling measures. Closely arranged hexagonal structure with central pin provides not only heat conduction from the hot wall to the cold wall, but also a rich convective heat transfer area, which can comprehensively improve the heat transfer efficiency. Relative to typical laminated structures, the helically structure of the honeycomb-like helically cavity makes the path of cooling air flow in the plate longer and makes more full use of cold air. From the aspect of reducing the flow resistance, the relatively independent unit avoids the interference between various airflows, eliminates the mutual collision and mixing of the cooling airflows from adjacent units, also avoids the problems of cooling gas back flow and cross flow. And reducing flow loss while ensuring full and effective heat transfer. In terms of the design of the air film hole, the hole with rectangular cross section used in the invention is flatter than the round hole used in the laminated structure, and the air film outflow has better attachment and better air film covering effect. In addition, the connection between the film hole and the cavity is smoother in the invention, which has greater advantages in reducing the flow resistance and improving the film covering effect. And the support rib structure is formed between each unit, which can effectively strengthen the strength of the blade compared with the spoiler pin connection in the laminate.

### Beneficial Effects of the Invention:

1. More Full use of Space

In typical laminate structure, the cooling structural elements, such as holes and pins, and units are all arranged in a quadrilateral manner, while them in the present invention are arranged in a hexagonal honeycomb manner. As shown in FIG. 3, number of the structural element in the invention is increase by about 15% relative to the old manner under the same unit spacing.

2. Reduce the Flow Resistance and Loss

Compared with the original laminate structure, first of all, the invention has reduced the flow resistance and loss by about 10-15%, and then the efficiency of the whole engine is improved. As shown in FIG. 4, due to the units are interconnected in typical laminate structure, the cooling gas in adjacent unit will intersect, impact and mix with each other, and there may be the phenomenon of cross and back flow. However, each unit of the invention is relatively independent, so it can avoid the mixing of cool gas and thus reducing the flow loss.

In terms of airflow turning angle: the cooling gas entering the laminated structure needs to turn of 90° in the narrow channel, and when flowing out of the structure, part of the airflow needs to turn of 135-160° at the entrance of the film hole. These excessive turning angles will cause a significant increase in flow resistance. In the present invention, when the cold gas enters and flows out of the cooling chamber, the turning angle both is 20-45°, which is approximately equal to the incident angle ∠A1 and the exit angle ∠A2 numerically, and is substantially smaller than the laminated structure.

In addition, in the process of cold gas flow, the large expansion and contraction of the cross-sectional area of the passage will cause energy loss, which is the case of the laminate structure. The larger size of the cavity space relative to the hole makes the air flow experience two approximate throttling flows when entering and leaving the laminate structure. The cross-sectional area of the passage of the invention is roughly the same along the path, and avert the expansion and the throttling phenomenon, so the resistance of the relative laminate structure is smaller.

3. Enhance the Resistance to Load

When turbine blade working mainly bear the load of the following aspects: centrifugal load caused by high-speed rotating, the aerodynamic load imposed by the gas flow and vibratory load caused by vibration. These loading on the blade matrix presents deformation trends such as stretching, torsion and bending, and produces corresponding stresses. In addition, the thermal stress caused by uneven heat expansion. When these stresses are coupled together. When these stresses are coupled together and exceed the limits that the material can withstand, the structure will be destroyed. As shown in FIG. 5, for the laminate structure, it is equivalent to open a cavity in solid wall of the blade. The reduction of this material will lead to the reduction of load resistance of the blade. In order to make up for the loss of blade strength, the pins are used to connect the inner and outer walls to play a strengthening role. Although, the compression resistance of the structure is increased, but the bending and torsional resistance is weak because of this approximate point support, so the effect on the structural strengthening is limited. In the invention, a hexagonal reticular supporting rib structure is used inside the cavity to connect the inner and outer walls, which can improve the overall anti-compression, bending and torsional load capacity of the structure in multiple directions by more than 20%, and improve the safety and reliability of the whole engine.

4. Improved Cooling Effect of Blade

Relative to the laminated structure, in the invention, integrated cooling effect improved by about 8% through enhance internal and external cooling of the turbine blade.

First of all, the invention makes full use of cooling gas. As shown in FIG. 4, after the cooling air enters the inner cavity in the laminated structure, it usually flows out through the air film hole after a half circle around the pin. In the honeycomb spiral cavity structure, the cooling air must flow around the pin for more than a circle before it flows out, lead to flow path becomes longer, and the total heat exchange with the wall surface is larger.

In addition, in the invention, heat conduction is better from high temperature wall on the gas side to low temperature wall inside the blade. As shown in FIG. 5, in laminate structure, pins are main structure to heat conduct and its capacity of heat transmission is related to total cross-sectional area. In invention, in addition to pins structure, the supporting ribs structure formed between the units are added to heat conduct, give rise to larger total cross-sectional area.

The invention is also superior to the existing laminated structure in terms of air film cooling outside the blade. The air film hole of the honeycomb spiral cavity is smoothly connected with the inner cavity, so cross section is approximately rectangular, as shown in FIG. 6. Compared with the round air film hole commonly used in laminate structure, this relatively flat scheme makes the air film flow more attached to the wall, so that a larger area of the blade surface at the same flow rate is covered and cooling efficiency is improved.

### BRIEF DESCRIPTION OF THE DRAWINGS

FIG. 1 shows the laminate structure and conventional turbine blades.

FIG. 2(a) shows the honeycomb-like helically cavity cooling structure of turbine blade.

FIG. 2(b) shows the partial enlarged detail view of honeycomb-like helically cavity cooling structure.

FIG. 3 shows the comparison of quadrangle and hexagonal unit arrangement.

FIG. 4 shows the comparison of cooling gas flow state inside laminate structure and honeycomb-like helically cavity.

FIG. 5 shows the comparison of section shape of two kind of structures.

FIG. 6 shows the comparison of air film hole coverage area of two kinds of structures.

FIG. 7(a) shows the 3D numerical simulation result of cooling gas flow in laminate structure.

FIG. 7(b) shows the 3D numerical simulation result of cooling gas flow in honeycomb-like helically cavity structure.

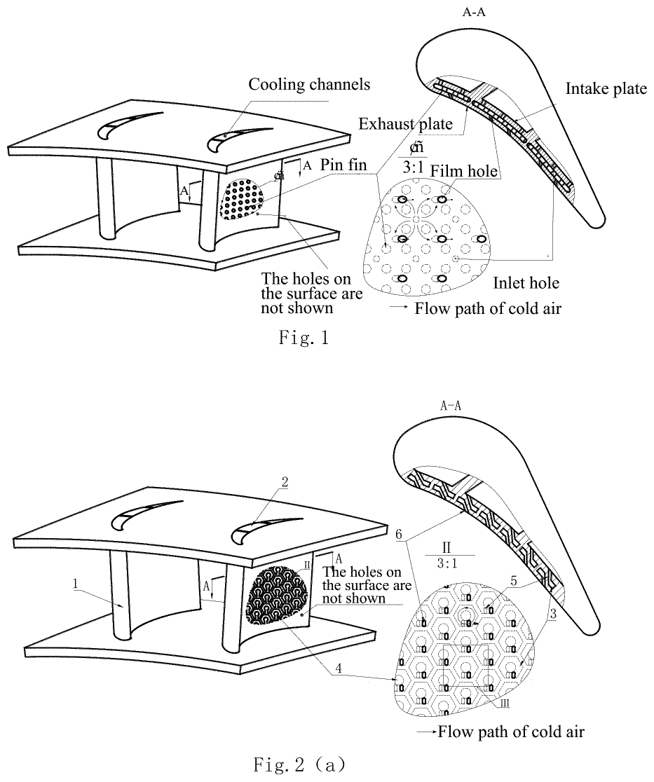

In the figures: 1. Hollow turbine blade; 2. Cooling channel; 3. Honeycomb-like helical cavity; 4. Pin fin; 5. Inlet hole; 6. Film hole; 7. Incident angle ∠A1; 8. Exit angle ∠A2; 9. Center line of inlet hole; 10. Center line of film hole.

### DETAILED DESCRIPTION

In order to make the content of the invention more easily and clearly understood, a further detailed description of the invention is given in accordance with the concrete embodiments and the attached figure.

### EMBODIMENT 1

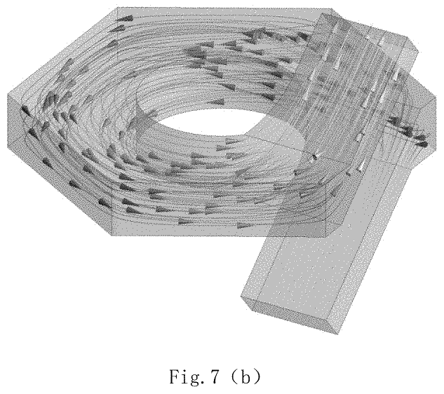

In the present invention, the internal cooling gas flow state is compared between the honeycomb-like helically cavity cooling structure and the laminate structure through 3D numerical simulation. According to the analysis of the FIG. 7(a) and FIG. 7(b), the cross-sectional area of passage in the invention is roughly the same along the flow, won't from flow sudden and throttling phenomenon. Furthermore, the airflow turning angle is smaller and no collide and mix between each other, so the relative resistance of the laminate structure is smaller.

### EMBODIMENT 2

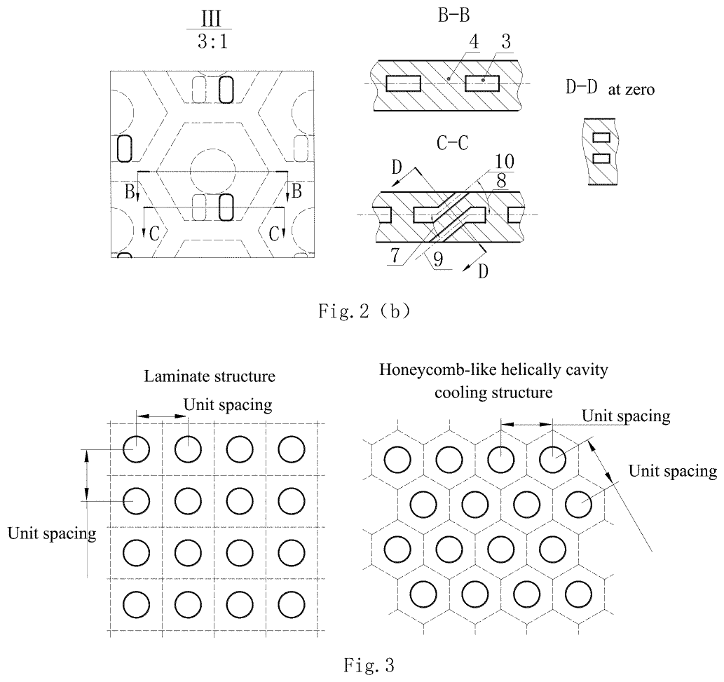

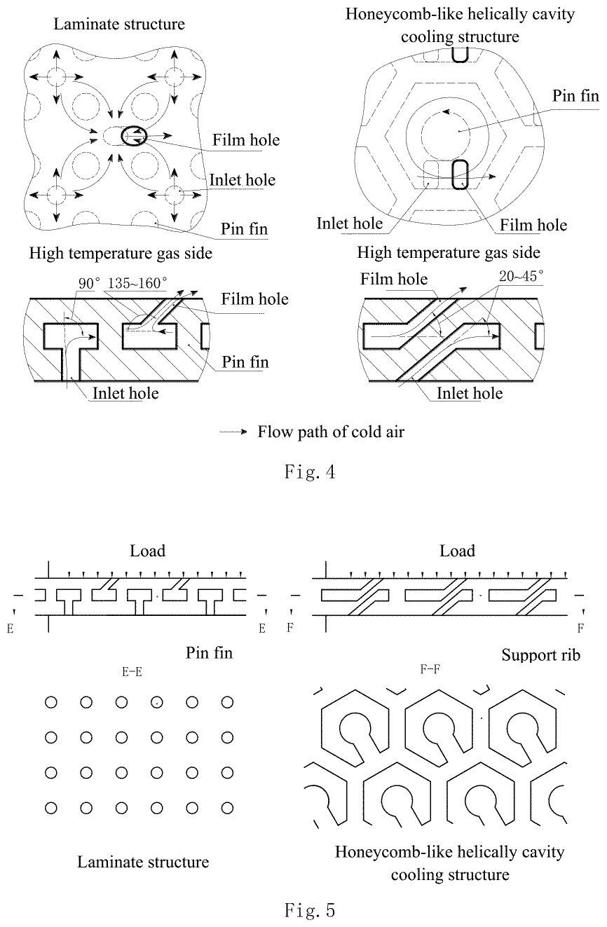

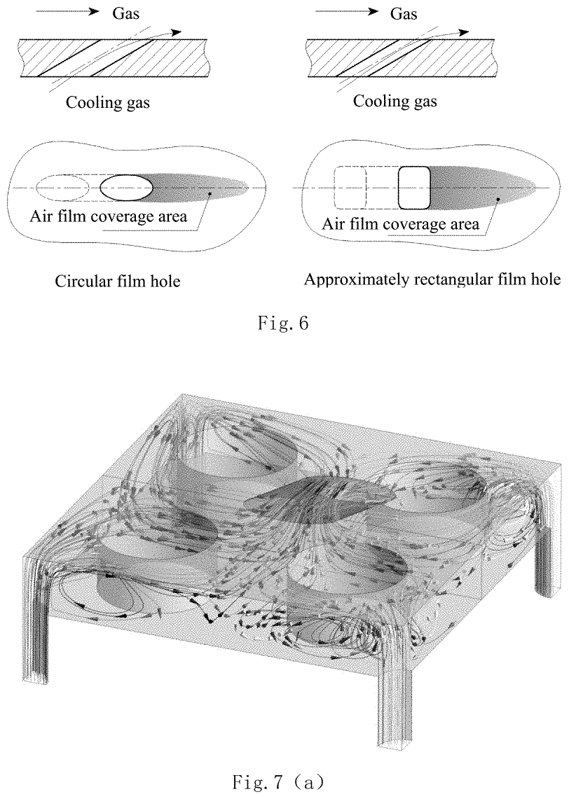

As shown in FIG. 2, honeycomb-like helical cavity cooling structure includes hollow turbine blade 1, honeycomb-like helical cavity 3 and pin fin 4.

Some cooling gas channels 2 are arranged inside the hollow turbine blade 1, multiple arrays of honeycomb-like helical cavity 3 are located in the blade wall of the hollow turbine blade 1. A cylindrical pin fin 4 is arranged in the center of the honeycomb-like helically cavity 3. Each honeycomb-like helically cavity 3 is a unit with a regular hexagon shape. Multi-units are arranged as a hive. In each unit, inlet hole 5 and film hole 6 were located on both sides of the blade wall, and the center line of inlet hole 9 and the center line of film hole 10 were parallel in the same vertical plane. The cross section is rectangle of inlet hole 5 and film hole 6, two holes connected with honeycomb-like helical cavity 3 by the circular arc slide. The angle between the center line of inlet hole 9 and the horizontal plane is incident angle ∠A1, the angle between the center line of film hole 10 and the horizontal plane is exit angle ∠A2. The incident angle ∠A1 and exit angle ∠A2 are both 20°.

### EMBODIMENT 3

Some cooling gas channels 2 are arranged inside the hollow turbine blade 1, multiple arrays of honeycomb-like helical cavity 3 are located in the wall of the hollow turbine blade 1. A cylindrical pin fin 4 is arranged in the center of the honeycomb-like helically cavity 3. Each honeycomb-like helically cavity 3 is a unit with a regular hexagon shape. Multi-units are arranged as a hive. In each unit, inlet hole 5 and film hole 6 were located on both sides of the blade wall, and the center line of inlet hole 9 and the center line of film hole 10 were parallel in the same vertical plane. The cross section is rectangle of inlet hole 5 and film hole 6, two holes connected with honeycomb-like helical cavity 3 by the circular arc slide. The angle between the center line of inlet hole 9 and the horizontal plane is incident angle ∠A1, the angle between the center line of film hole 10 and the horizontal plane is exit angle ∠A2. The incident angle ∠A1 and exit angle ∠A2 are both 30°.

### EMBODIMENT 4

Some cooling gas channels 2 are arranged inside the hollow turbine blade 1, multiple arrays of honeycomb-like helical cavity 3 are located in the wall of the hollow turbine blade 1. A cylindrical pin fin 4 is arranged in the center of the honeycomb-like helically cavity 3. Each honeycomb-like helically cavity 3 is a unit with a regular hexagon shape. Multi-units are arranged as a hive. In each unit, inlet hole 5 and film hole 6 were located on both sides of the blade wall, and the center line of inlet hole 9 and the center line of film hole 10 were parallel in the same vertical plane. The cross section is rectangle of inlet hole 5 and film hole 6, two holes connected with honeycomb-like helical cavity 3 by the circular arc slide. The angle between the center line of inlet hole 9 and the horizontal plane is incident angle ∠A1, the angle between the center line of film hole 10 and the horizontal plane is exit angle ∠A2. The incident angle ∠A1 and exit angle ∠A2 are both 45°.

1. A honeycomb-like helically cavity cooling structure of turbine blade, comprising hollow turbine blade, honeycomb-like helically cavity and pin fins;
cooling channels are arranged inside the hollow the hollow turbine blade, the cooling channels provide low-temperature cooling gas to flow inside the blade and cools the blade; multi-arrays of the honeycomb-like helically cavity are arranged in blade wall of the hollow turbine blade, for cooling gas to enter and convective cooling; the pin fin is arranged in center of the honeycomb-like helically cavity, the pin fin is cylindrical;
each honeycomb-like helically cavity is a unit with a regular hexagon shape, and multi-units are arranged as hive; inlet hole and film hole are located on both sides of the blade wall, and center line of inlet hole and center line of film hole are parallel in same vertical plane; angle between the center line of inlet hole and horizontal plane is incident angle, angle between the center line of film hole and the horizontal plane is exit angle; the incident angle and exit angle are both acute.

2. The honeycomb-like helically cavity cooling structure of turbine blade according to claim 1, wherein cross sections of the inlet hole and film hole are rectangular.

3. The honeycomb-like helically cavity cooling structure of turbine blade according to claim 1, wherein both angle of the incident angle and exit angle are 20-45°.

4. The honeycomb-like helically cavity cooling structure of turbine blade according to claim 1, wherein the inlet hole and film hole are smoothly connected with passage in the honeycomb-like helically cavity by circular arc slide.

5. The honeycomb-like helically cavity cooling structure of turbine blade according to claim 3, wherein the inlet hole) and film hole are smoothly connected with passage in the honeycomb-like helically cavity by circular arc slide.

6. The honeycomb-like helically cavity cooling structure of turbine blade according to claim 3, wherein both typical angle of the incident angle and exit angle are 30°.

7. The honeycomb-like helically cavity cooling structure of turbine blade according to claim 5, wherein both typical angle of the incident angle and exit angle are 30°.
